(19) United States
(12) Patent Application Publication
(10) Pub. No.: US 2015/0286865 A1
(43) Pub. Date: Oct. 8, 2015

(54) COORDINATION OF OBJECT LOCATION DATA WITH VIDEO DATA

(71) Applicants: Sony Corporation, Tokyo (JP); Sony Network Entertainment International LLC, Los Angeles, CA (US)

(72) Inventors: Charles MCCOY, Coronado, CA (US); True XIONG, San Diego, CA (US)

(73) Assignees: Sony Corporation, Tokyo (JP); Sony Network Entertainment International LLC, Los Angeles, CA (US)

(21) Appl. No.: 14/247,615

(22) Filed: Apr. 8, 2014

(51) Int. Cl. G06K 9/00; G06K 9/62; G06T 7/20

(52) U.S. Cl. CPC G06K 9/00624; G06T 7/20; G06K 9/6267

(57) ABSTRACT

An object tracking system automatically generates metadata about locations of objects within a scene. The objects may then be associated with one or more objects within the scene.

### FIELD OF THE INVENTION

The present invention is directed to an object tracking system which can automatically generate metadata about the location of one or more objects in a video signal. The metadata is then inserted into the video signal. The object may then he associated with one or more objects within the video signal.

### BACKGROUND

Surveillance systems are used for tracking objects within an area. U.S. Publication No. 2008/0774484 discloses one or more video surveillance cameras for capturing video of a moving object within a scene. A processor geo-references the captured video of the moving object to a geospatial mode and generates a display comprising an insert/iron superimposed into the scene of the geo-spatial model.

U.S. Publication No. 2011/0145257 is directed to enhance processing of geo-referenced video feeds. A processor overlaps selected geospatially-tagged metadata into a viewable area as well as appropriate annotations. This allows a user to view the video while having access to information such as names, locations and other information such as size and speed.

The prior art currently does not track objects in association with one another.

### SUMMARY

The present invention is directed to an object tracking system in which metadata for object location within a video surveillance system is used to track the objects and for association of the objects with other objects.

The object tracking system includes sensor systems which obtain information about a scene. An analysis unit analyzes the information to identify objects and locations thereof within the scene. A processor generates metadata identifying each object location. An inserter inserts metadata into the information about the scene.

The object tracking system information about the scene Is video data. The metadata for each object in a frame of the video data is inserted into the video data.

The sensor system of the object tracking system includes sensing visual and non-visual objects.

The sensor system includes sensors detecting at least radio frequency signals and temperature.

The metadata of location of the objects is for tracking the movement of the objects over time.

A mapping unit, draws a line on a map to map the identifying objects movement over time.

A second analysis unit analyzes metadata to determine if two or more objects are associated with one another by being within a predetermined distance of one another over predetermined period of time.

The objects that are associated with one another include people and personal and non personal items.

A determination can be made if the detected object is previously tracked in previous video frames. If the detected object is not previously tracked, the video frames in which the new object appears are highlighted. Also, similar frames can be highlighted if a object present in a previous frame is no longer present.

Other aspects of the invention will become apparent from the following description and drawings, all of which illustrate the principles of the invention by way of example only.

### BRIEF DESCRIPTION OF THE DRAWINGS

FIG. 1 shows an example of the object tracking system.

FIG. 2 shows an example of generating metadata.

FIG. 3 shows an example of associating objects with one another.

### DETAILED DESCRIPTION

The present invention will now be described with reference to the accompanying drawings. The invention may be embodied in different forms and should not be limited to the embodiment disclosed below.

The present invention discloses an object tracking system which automatically generates metadata about the location of various objects in an area under surveillance. The generated metadata is associated with a video signal. Thus, the object location data is incorporated into the video signal as metadata.

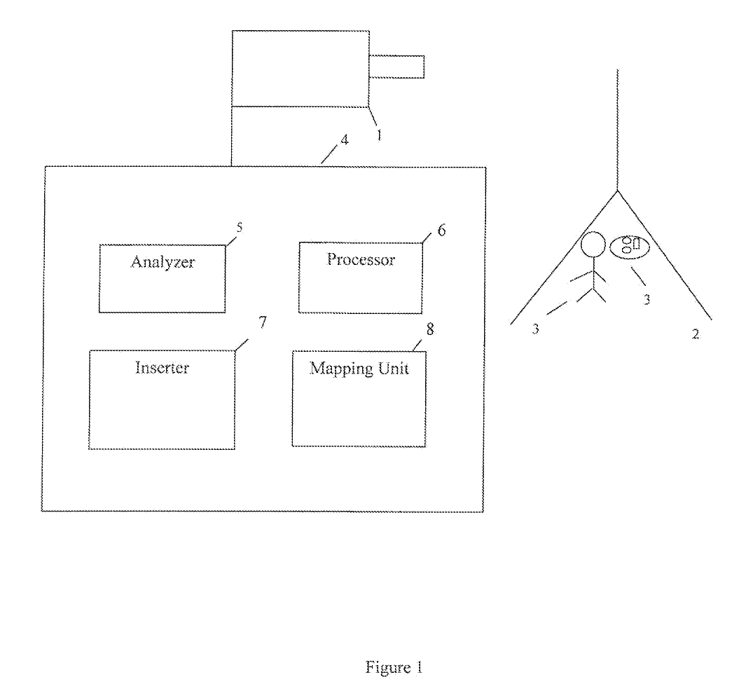

FIG. 1 shows an example of the object tracking system. One or more cameras 1 are provided in a particular area of interest 2. Objects 3 within the area are identified by a main processor 4, including analyzer 5, processor 6, inserter 7 and mapping unit 8. The main processor 4 analyzes the video to determine objects in the video, identify the objects and determine their location. The processor then inserts the metadata about the objects' location into the video where the objects appears. The metadata can be added to each frame. Alternatively, in some implementations the frames of the video are modified, while in other implementations the metadata is stored in the video without modifying the video frames. The generated metadata is visible in a video frame with the tracked objects. In particular, the location information about the tracked objects is visible in the video frame.

Various actions can be initiated based on whether the tracked objects were previously tracked objects or new objects. For example, the presence of a new object may trigger a review of archival video or highlight a portion of the frame of the video where the new objects are detected. Statistics can be generated when a particular item is present in the video. That is, various objects can be tracked over time in the video to determine when certain objects are present in a particular area.

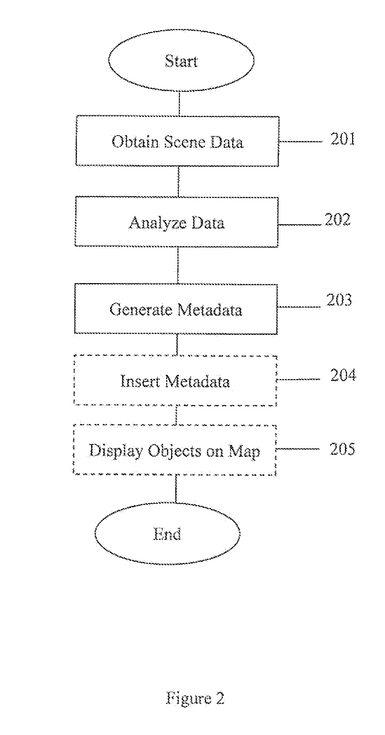

The metadata, of the locations where objects are, can be used for tracking the movement of objects over time. Thus, a map can show a line of travel of the objects over time (see FIG. 2, Step 205).

FIG. 2 shows an example of generating metadata. First, sensors and/or cameras obtain readings or images of a scene (Step 201). Next, the scene is analyzed for visual and non-visual objects within the scene to determine location of objects within the scene (Step 202). Metadata is generated identifying each objects' location within the scene (Step 203). In one embodiment, the metadata is then inserted into the video signal (Step 204). In another embodiment, lines on a map tracking the objects over time are generated and displayed (Step 205). Note, Steps 204 and 205 are optional steps which may be performed.

In addition, using the object tracking system of the present invention allows tracked objects location to be coordinated with visual movement in the video frame. By analyzing the portion of the video frame, a determination can be made if other objects within the frame are associated with one another. For example, a face/person detected in a video frame near the location of a tracked object, such as a cell phone, can be coordinated with the tracked object (person).

By tracking objects and determining if the movement of the objects are associated with other objects, a relationship between Objects can be identified. For example, a video segment may show a car with a license plate and a person. Since the car, license plate and person are within a predetermined distance of one another and are moving together as a unit, the person may be associated with the car. Alternatively, the ear and its license place can be associated with one another.

While the above description discloses identifying a location of an object in a video signal, objects can be identified using non-visual data such as by temperature, radio frequency identification (RFID), etc. Thus objects can be identified visually, non-visually or a combination of both. For example, a person's location can be identified visually such as from a video surveillance camera while his/her cell phone may not be visible. However, the location of the cell phone may be identified by triangulation from radio frequency (RF) sources. Furthermore, since the s location and cell phone location are congruent, the cell phone and person may be associated with one another. Although the example is only for associating two objects, the association may be for more than two objects (e.g., person, cell phone, backpack, umbrella, etc.).

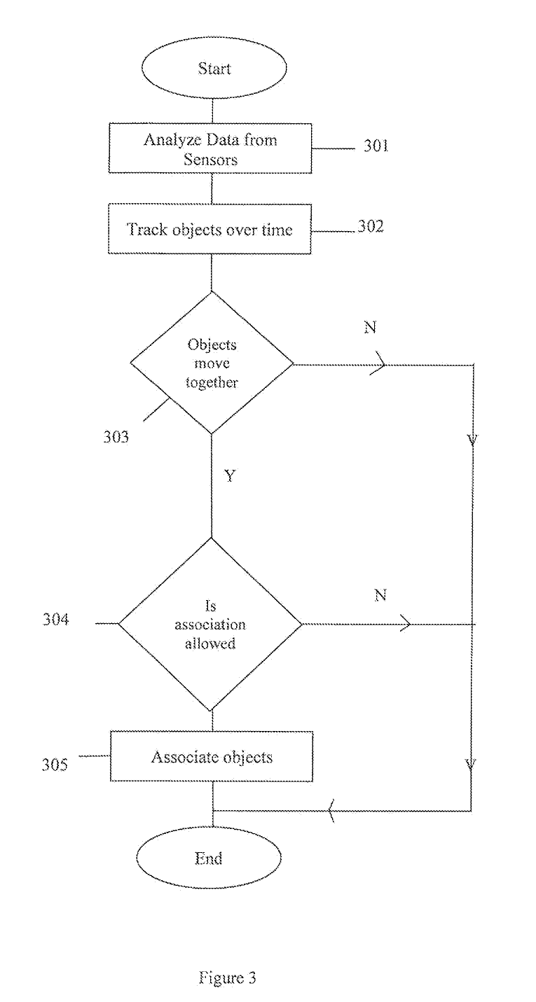

FIG. 3 shows an example of associating objects with one another. First, output from sensors is analyzed to determine if two car more objects are within a predetermined distance one another (Step 301). The output from the sensors may be analyzed to include analysis of video data, analysis of radio frequency data as well as any other sensor output. Next, the objects are tracked over a predetermined period of time (Step 302). A determination is made if the objects more together as a unit over a predetermined period of time or the objects move to be in close proximity of one another (Step 303). A determination can be made if association of objects is allowed (Step 304), if the objects move together and the association is allowed, then they are associated with one another (Step 305).

Although the above examples may be used in a surveillance type of security system, the present invention is not limited thereto. For example, advertisers and commercial users may be trying to determine certain types of behavior. For example, the advertiser/commercial user may be trying to determine the number of people associated with coffee cups versus coffee cans. In other words, the present invention can be used to statistically associate one object (e.g., person) with another object (e.g., color of a shirt). After a number of such associations, a determination can be made that people who like red shirts also like blue shirts. Accordingly a prediction can be made to associate a particular object or person with another object or person based upon statistical analysis about historical situations. Using facial recognition with the object tracking system of the present invention, a determination can be made that people who like red shirts are more likely to eat tacos than people who wear blue shirts based on statically analysis.

The object tracking system of the present invention may include a dictionary/database of objects that should not be associated with one another alone or in a specific location. The objects that should not be associated with one another may vary by location (see FIG. 3, Step 304).

The present invention can be used to map movement of linked objects moving together and subsequently separated. For example, a map can be drawn of objects moving to an area of interest and then separated (e.g., a person with a backpack i.e. two linked objects move to a restricted area and then they are separated).

With the present invention, objects can be automatically tracked and metadata automatically generated. The metadata can then be used to associate objects with each other. The present invention can be used not only for security reasons but also for commercial users.

While the present invention has been described with reference to illustrative embodiments, this description is not intended to be construed in a limiting sense. Various modifications and combinations of the illustrative embodiments will be apparent to a person skilled in the art. Therefore, the appended claims encompass any such modifications or embodiments.

What is claimed is:

1. An object tracking system comprising:
a sensor system detecting information about a scene;
an analysis unit analyzing the information to identify objects and location thereof within the scene, wherein the analysis unit determines an association of one object with at least one other object;
a processor generating metadata identifying each object location; and
tracking unit tracking object movement of the associated objects based on the generated metadata identifying each object location.

2. The object tracking system according to claim 1, wherein the information contains video data and the metadata for each object is inserted into the video data.

3. The object tracking system according to claim 1, wherein the sensor system includes sensors sensing visual and non-visual data.

4. The object tracking system according to claim 1, wherein the sensor system includes at least one sensor detecting at least radio frequency signals.

5. The object tracking system according to claim 1, wherein the sensor system includes at least one sensor detecting at least temperatures.

6. The object tracking system according to claim 1, wherein the tracking unit tracks the movement of objects over time based upon the metadata identifying each object location.

7. The object tracking system according to claim 6, farther comprising a mapping unit which draws a line on a map to map each identified objects' movement over time.

8. The object tracking system according to claim 1, wherein the analysis unit further analyzes metadata of objects to determine if two or more objects arc associated with one another by being within a predetermined distance of one another over a predetermined period of time.

9. The object tacking system according to claim 1, wherein the objects that are associated with one another include people and personal and non-personal items.

10. The object tracking system according to claim 1, wherein the analysis unit determines if detected objects are present in both of two consecutive video frames.

11. The object tracking system according to claim 10, wherein if objects are not previously tracked, video frames in which new objects appear are highlighted.

12. The object tracking system according to claim 1, further comprising an inserter inserting metadata into information about the scene, the metadata including the determined object association.

13. The object tracking system according to claim 1, wherein the analysis unit determines if objects are associated with one another by correlations in the movements of the objects based upon identifying each object location.

14. The object tracking system according to claim 10, wherein if an object which is being tracked is no longer detected, video frames are highlighted when the object is no longer detected.

15. A method of tracking objects comprising the steps of:
detecting information about a scene;
analyzing the information to identify objects and location thereof within a scene, including determining an association of one object with at least one other object;
generating metadata identifying each object location; and
tracking movement of the associated objects based on the generated metadata identifying each object location.

16. The method according to claim 15, wherein the information detected is video data and the metadata for each object is inserted into the video data.

17. The method according to claim 15, wherein the detection of information is by sensors sensing visual and non-visual data.

18. The method according to claim 17, wherein the sensors include sensors detecting at least radio frequency signals.

19. The method according to claim 15, wherein the metadata identifying each object location is for tracking the movement of objects over time.

20. The method according to claim 19, further comprising the steps of drawing a line on a map to map each identified objects' movement over time.

21. The method according to claim 15, further comprising the step of analyzing metadata to determine if two or more objects are associated with one another by being within a predetermined distance of one another over a predetermined period of time.

22. The method according to claim 15, wherein the objects that are associated with one another include people and personal and non-personal items.

23. The method according to claim 15, further comprising the step of determining if detected objects are present in both of two consecutives video frames.

24. The method according to claim 23, wherein if objects are not previously tracked, video frames in which new objects appear are highlighted.

25. The method according to claim 15, further comprising the step of predicting relationships between objects based on analyzing the metadata and statistically identifying relationships therebetween.

26. The method according to claim 15, further comprising the step of categorizing a plurality of associations of objects and associating a particular object with at least one other particular object based on statistical analysis of the categorization.

27. The method according to claim 15, further comprising the step or inserting metadata into the information about the scene, the metadata including the determined object association.

28. The method according to claim 17, wherein the detection of information is by sensors detecting at least temperatures.

29. The method according to claim 15, further comprising the step of determining if objects are associated with one another by correlations in movement of the objects based upon identifying each object location.

30. The method according to claim 23, wherein if an object which is being tracked is no longer detected, video frames are highlighted when the object is no longer detected.
